(19) United States
(12) Patent Application Publication
(10) Pub. No.: US 2007/0270069 A1
(43) Pub. Date: Nov. 22, 2007

(54) FRICTION MATERIAL AND SYSTEM AND METHOD FOR MAKING THE FRICTION MATERIAL

(75) Inventors: JAMES MARTIN LEE, WATERTOWN, NY (US); ERIC ARTHUR SCHUELER, MAINEVILLE, OH (US); MATTHEW JOSEPH TRIPPEL, CENTERVILLE, OH (US)

Correspondence Address: MATTHEW R. JENKINS, ESQ., 2310 FAR HILLS BUILDING, DAYTON, OH, 45419, US

(73) Assignee: SULZER EUROFLAMM US INC., Dayton, OH (US)

(21) Appl. No.: 11/419,023

(22) Filed: May 18, 2006

(51) Int. Cl. B32B 3/06; D04B 7/12; D04B 9/14

(52) U.S. Cl. 442/366; 442/301; 428/102; 66/190

(57) ABSTRACT

A system and method for providing a material for a friction element of a power transmission-absorption assembly and a method of making the material is disclosed. The material has preselected channel configuration which provides a plurality of channels defined at least in part by a pattern of stitches, such as a plurality of rows of stitches.

### BACKGROUND OF THE INVENTION

1. Field of the Invention

The present invention relates to a system and method for creating a mat or web having a pattern of configuration of stitches that define channels or grooves for controlling fluid flow across or through a friction material segment.

2. Description of the Related Art

In clutches, brakes, automatic transmissions, limited slip differentials, hoists and similar friction power transmission and absorption devices, there is generally provided one or more sets of cooperating members in which one of the cooperating members drives the other. It is not uncommon for these cooperating members to move in cooling medium or liquid which is generally some type of lubricating oil, and frequently the oil is force circulated about and between the engaging surfaces of the cooperating members so as to continuously lubricate and cool them. For instance, the cooperating members in slipping torque converter clutch applications require dissipation of heat from the slipping interface of the friction material and the corresponding engagement surface to prevent the weakening of the adhesive bond between the friction material and the member the friction material is adhered to typically found at high temperatures, prevent the oxidation of the friction modifiers typically found within the transmission fluid, and to prevent the deterioration of friction properties typically experienced at high temperatures. Dissipating heat from the cooperating members also reduces the heat absorbed by the friction material, reducing structural deterioration of the friction material that has typically been experienced at approximately 400° F.-500° F. with cellulose based friction materials. When cooperating members have been exposed to high temperatures for extended periods of time, friction modifiers within the transmission fluid have been found to oxidize and deposit on the friction material, reducing the effective and smooth transmission of torque within the power transmission device. In all instances, adequate cooling is required to improve the performance and life of the friction system.

Further, in cooperating members such as manual transmission synchronizer assemblies, a hydrodynamic oil film often exists between cooperating members which can prevent the effective transfer of torque between the cooperating members. The presence of hydrodynamic oil films is most prevalent at high fluid viscosity conditions such as cold ambient temperatures. In such cases, channeling fluid away from the interface of the cooperating members is required to effectively transmit torque between such members. Providing channels or grooves for the dissipation of such hydrodynamic films has been found to provide improved performance, shiftability, and driver comfort, especially in low temperature environments. In addition to the above applications, the same principles are required for clutch disk applications, limited slip differentials, lock-up clutches, launch clutches, transmission bands, and other similar torque transmission devices. In order to accomplish circulation of the cooling medium within blocker rings, clutch plates, transmission bands and the like, the prior art has provided grooves or slots directly in engaging surfaces of one or both of the cooperating members or in friction material affixed hereto. For example, a friction material may be a brass coating or a paper liner requiring grooves for cooling and fluid film dissipation as discussed in U.S. Pat. No. 4,267,912 to Bauer et al., U.S. Pat. No. 4,878,282 to Bauer, and U.S. Pat. No. 4,260,047 to Nels. In each case, these materials require the addition of grooves in the friction material before, after, or during bonding in the respective applications.

Forming grooves within the friction material of cooperating members or forming grooves with a woven material construction not only adds complexity to the manufacture of such friction materials and the power transmission-absorption device, but also is a method limited in its ability to effectively circulate cooling medium there through. In order to reduce or eliminate the hydrodynamic friction stemming from oil or cooling medium lying on the surface of the friction material engaging the driving member, an improved friction material for circulating the cooling medium is required, especially one which may be varied according to desired parameters.

Prior art friction material also includes certain pyrolitic carbon materials as seen in U.S. Pat. No. 4,700,823 to Winckler and U.S. Pat. No. 4,291,794 to Bauer. In such friction material, a meshed cloth substrate formed of carbon fibers is provided with a coating of carbon or other material being deposited on the fibers by chemical vapor deposition. This type of friction material has the characteristic of a relatively open mesh which readily allows penetration by an adhesive for improved bonding, as well as a certain degree of porosity therethrough. However, as pointed out in the '794 patent, addition of grooves is used to improve circulation of fluid between the friction faces of the cooperating members of the power transmission or energy absorption assembly. This type of friction material also does not provide high strength fiber bonding at the interfacing friction surface of the material, resulting in introduction of debris into the operating environment. This type of friction material has also been found to provide an inadequate level of fluid permeability, specifically resulting from a substantial reduction in the cross-section of the fluid groove as the friction surface wears. Also, oxidized friction modifiers have been found to obstruct passage of fluid through the often narrow and shallow grooves of woven materials. Moreover, it has been found that such friction material is difficult to compress to a desired thickness such as during the process of bonding it to a member while maintaining a high degree of porosity there through.

Other friction materials of the prior art may also be a carded, lapped, or needle-punched material as seen in U.S. Pat. No. 6,835,448 to Menard et al., and U.S. Pat. No. 5,807,618 to Menard et al. These materials, while they provide high strength for high energy applications, also provide a deficiency in fluid flow inherently through or across the material due to the dense nature of these materials resulting from the intimate fiber to fiber contact structure of the material. Addition of grooves after or during adhesive bonding of these materials is often necessary to provide the necessary amount of fluid flow to dissipate oil films and provide necessary cooling.

Prior art friction materials also include certain woven carbon materials as seen in U.S. Pat. No. 6,439,363 to Nels and U.S. Pat. No. 5,662,993 to Winckler. These materials consist of a woven PAN or pre-oxidized PAN cloth that then undergoes a secondary carbonizing process. Post-carbonized woven PAN materials have been found to provide a deficiency in fluid flow across and through the materials due to the closed woven structure of the material. Many woven structures do not provide well-defined grooves that allow fluid to communicate freely through the material, resulting in appreciable losses in fluid flow. The voids in the material between the warp and weft yarns of such materials have also been found to create areas where oxidized ATF friction modifiers deposit and build up, also limiting the ability of fluid to flow through the woven mesh. These ATF friction modifier deposits have also been found to have a detrimental effect on the friction performance of such materials. Additionally, the sites of the woven material where the warp and weft yarns overlap also create a peak contact surface which fails to distribute compressive forces evenly across the surface of the material. Materials of this construction have been found to have a deficiency in material integrity under high compressive loads, leading to fiber and yarn fracture and shatter at sites of high unit loading, resulting in undesirable debris within the transmission and undesirable material wear. A method for introducing surface texture into a material that allows fluid to pass over and thru the interfacing surfaces of cooperating members that evenly distributes load and allows a degree of compliance is desirable to improve over the existing art.

Woven and chemical vapor deposition materials that provide relatively high flow compared to paper, needle-punched, carded, lapped, knitted, fleece-knitted materials without added grooves are typically low productivity, complex products to manufacture. A low-cost alternative to existing woven and chemical vapor deposition materials that provides improved fluid flow across and through the material is desirable.

FIGS. 1A-1C illustrate several prior art stitch patterns shown in U.S. Pat. No. 3,967,472.

What is needed, therefore, is a friction material that overcomes the problems in prior art.

### SUMMARY OF THE INVENTION

It is therefore an object of the invention to provide a stitched mat or web that provides a predetermined configuration or pattern of channels.

Another object of the invention is to provide a system and method for creating a plurality of material segments having a plurality of channels defined by stitches.

Still another object of the invention is to provide a system and method for defining a pattern of series of channels in a friction material or friction material segments that facilitates cooling the part on which the friction material or friction material segments are mounted.

In one aspect, one embodiment comprises a friction material comprising a plurality of materials formed to provide a web from which a friction material segment is provided; a plurality of stitches in the web to provide a stitched web; the plurality of stitches defining a plurality of channels in the friction material segment to facilitate transferring heat away from a friction element onto which the friction material segment is situated.

In another aspect, another embodiment of the invention discloses a friction material comprising material segments; and a plurality of stitches stitched in a predetermined pattern in each material segment; the plurality of stitches defining a plurality of channels through which fluid may flow to facilitate cooling a friction element on which the material segments are adhered.

In still another aspect, another embodiment of the invention discloses a method for producing a friction material, comprising the steps of forming a plurality of rovings, fibers, filaments, bundles or yarns; carding, spin-binding, weaving, lapping, needle-punching, knitting, hydro-entangling, fleece-knitting, air-laying, wet-laying or a combination thereof the plurality of rovings, fibers, filaments, yarns and or bundles into a mat or web; and reinforcing the mat or web with a plurality of stitches.

In yet another aspect, another embodiment of the invention discloses a method for producing a friction element comprising the steps of providing a part that is used in a friction environment; providing a mat or web comprising plurality of rovings, fibers, filaments, bundles or yarns; stitching the mat or web with a predetermined pattern of stitches to form a plurality of channels, respectively; processing the mat or web to provided a plurality of material segments; and adhering the plurality of material segments to the part such that the plurality of channels are situated in order to facilitate fluid to flow from a first area associated with a first side of the friction element to a second area associated with a second side of the friction element.

In still another aspect, another embodiment of the invention comprises a system for making a friction element, the system comprising a mat station for creating a mat comprising a plurality of rovings, fibers, filaments, bundles or yarns; a stitching station for stitching the mat with a predetermined pattern of stitches to form a plurality of channels, respectively; a carbonizing station for carbonizing the mat; a processing station for reinforcing the mat with a binder material; a chemical vapor deposition station for depositing carbon on the surface of the material; a processing station for processing the mat or web to provided a plurality of material segments; and a bonding station for bonding the plurality of material segments onto a part to provide the friction element such that the plurality of channels are situated in a predetermined order to facilitate fluid to flow from a first area associated with a first side of the friction element to a second area associated with a second side of the friction element.

In another aspect, this invention comprises a friction material comprising a plurality of materials formed to provide a web from which a friction material segment is provided; and a plurality of stitches in said web to provide a stitched web; said plurality of stitches defining a plurality of channels in said friction material segment to facilitate transferring heat away from a friction element onto which said friction material segment is situated, wherein the plurality of stitches comprise a plurality of natural rovings, plurality of natural fibers, plurality of natural filaments, plurality of natural threads, bundles, plurality of natural yarns or plurality of natural braids.

In still another aspect, this invention comprises a friction material comprising a plurality of materials formed to provide a web from which a friction material segment is provided; and a plurality of stitches in said web to provide a stitched web; said plurality of stitches defining a plurality of channels in said friction material segment to facilitate transferring heat away from a friction element onto which said friction material segment is situated, wherein said plurality of stitches comprises a plurality of rovings, a plurality of fibers, a plurality of filaments, a plurality of threads, a plurality of bundles, a plurality of yarns, or plurality of braids, wherein the plurality of stitches comprise a combination of natural and synthetic fibers, filaments, threads, bundles, yarns or braids.

In yet another aspect, this invention comprises a friction material comprising a plurality of materials formed to provide a web from which a friction material segment is provided; and a plurality of stitches in said web to provide a stitched web; said plurality of stitches defining a plurality of channels in said friction material segment to facilitate transferring heat away from a friction element onto which said friction material segment is situated, wherein the plurality of channels are generally parallel.

In still another aspect, this invention comprises a friction material comprising a plurality of materials formed to provide a web from which a friction material segment is provided; and a plurality of stitches in said web to provide a stitched web; said plurality of stitches defining a plurality of channels in said friction material segment to facilitate transferring heat away from a friction element onto which said friction material segment is situated, wherein the friction element comprises a first edge and a second edge, the plurality of channels extending between the first and second edges, wherein the plurality of channels are generally parallel and extending between the first and second edges.

In yet another aspect, a friction material comprising a plurality of materials formed to provide a web from which a friction material segment is provided; and a plurality of stitches in said web to provide a stitched web; said plurality of stitches defining a plurality of channels in said friction material segment to facilitate transferring heat away from a friction element onto which said friction material segment is situated, wherein the friction material comprises a torque transmission device, wherein the torque transmission device is a transmission band.

In still another aspect, this invention comprises a friction material comprising material segments; and a plurality of stitches stitched in a predetermined pattern in each material segment; the plurality of stitches defining a plurality of channels through which fluid may flow to facilitate cooling a friction element on which the material segments are adhered, wherein the plurality of stitches define a plurality of generally parallel channels that are generally linear.

In yet another aspect, this invention comprises a friction material comprising material segments; and a plurality of stitches stitched in a predetermined pattern in each material segment; the plurality of stitches defining a plurality of channels through which fluid may flow to facilitate cooling a friction element on which the material segments are adhered, wherein the plurality of stitches define a plurality of generally non-parallel channels that are generally non-linear.

In still another aspect, this invention comprises a friction material comprising material segments; and a plurality of stitches stitched in a predetermined pattern in each material segment; the plurality of stitches defining a plurality of channels through which fluid may flow to facilitate cooling a friction element on which the material segments are adhered, wherein the material segment comprises a first edge and a generally opposed second edge, the plurality of stitches define a plurality of generally parallel channels that are generally linear and situated at a predetermined angle relative to the first edge, wherein the plurality of stitches are situated at a predetermined acute angle relative to the center line of the material segment.

In yet another aspect, this invention comprises a friction material comprising material segments; and a plurality of stitches stitched in a predetermined pattern in each material segment; the plurality of stitches defining a plurality of channels through which fluid may flow to facilitate cooling a friction element on which the material segments are adhered, wherein the friction element comprises a torque transmission device, wherein the torque transmission device is a transmission band.

In still another aspect, this invention comprises a method for producing a friction element, comprising the steps of: providing a part that is used in a friction environment; providing a mat or web comprising plurality of rovings, fibers, filaments, bundles or yarns; stitching said mat or web with a predetermined pattern of stitches to form a plurality of channels, respectively; processing said mat or web to provide a plurality of material segments; and adhering said plurality of material segments to said part such that said plurality of channels are situated in order to facilitate fluid to flow from a first area associated with a first side of said friction element to a second area associated with a second side of said friction element, wherein the stitching step further comprises the step of: stitching said mat or web with a predetermined pattern of stitches that are tensioned at a predetermined tension, wherein the method further comprises the step of selecting said predetermined tension based upon a determination of the size of at least one of the plurality of channels, wherein the predetermined tension is larger for larger cross-section areas of the plurality of channels and smaller for smaller cross-sections of the plurality of channels.

Other objects and advantages of the invention will be apparent from the following description, the accompanying drawings and the appended claims.

### BRIEF DESCRIPTION OF ACCOMPANYING DRAWING

FIGS. 1A-1C show stitches in the prior art;

FIG. 2 is a microphotograph of a mat or web prior to stitching or bonding;

FIG. 3 is a schematic diagram of the system in accordance with one embodiment of the invention;

FIG. 4 is schematic diagram of a method in accordance with one embodiment of the invention;

FIGS. 5A-5D are various views of a mat or web prior to stitching;

FIGS. 6A-6D illustrate a mat or web comprising a combination of fibers or particles prior to stitching;

FIGS. 7A-7C are several microphotographs showing several patterns of a plurality of stitches that define a plurality of channels;

FIGS. 8A-8B are microphotographs of the mat or web in FIGS. 7A-7C after a binder has been applied thereto;

FIGS. 9A-9E are various views of a stitch pattern in a mat or web;

FIGS. 10A-10D illustrate another embodiment of the invention showing a plurality of mats stitched together;

FIGS. 11A-11B illustrate another embodiment of the invention;

FIGS. 12A-12B illustrate another embodiment of the invention;

FIGS. 13A-13B illustrate a plurality of stitches or rows of stitches that are situation at a predetermined angle Θ;

FIGS. 14A-14B illustrate a plurality of rows of stitches oriented in different directions;

FIG. 15 illustrates a plurality of material segments that are stamped from a mat or web or material;

FIG. 16A-16C illustrates the segments situation on a part;

FIG. 17A-17C illustrate another embodiment of the invention showing a friction material situation on the part;

FIG. 18 illustrates another application of the friction material segments to a part wherein the segments have a plurality of cross channels;

FIG. 19 illustrates another embodiment of the invention;

FIGS. 20A-20B illustrate yet another embodiment of the invention;

FIGS. 21A-21C illustrate yet another application of the material segments; and

FIGS. 22A-22F illustrate a plurality of microphotographs that show the effect of compression on the mat or web.

### DETAILED DESCRIPTION OF PREFERRED EMBODIMENT

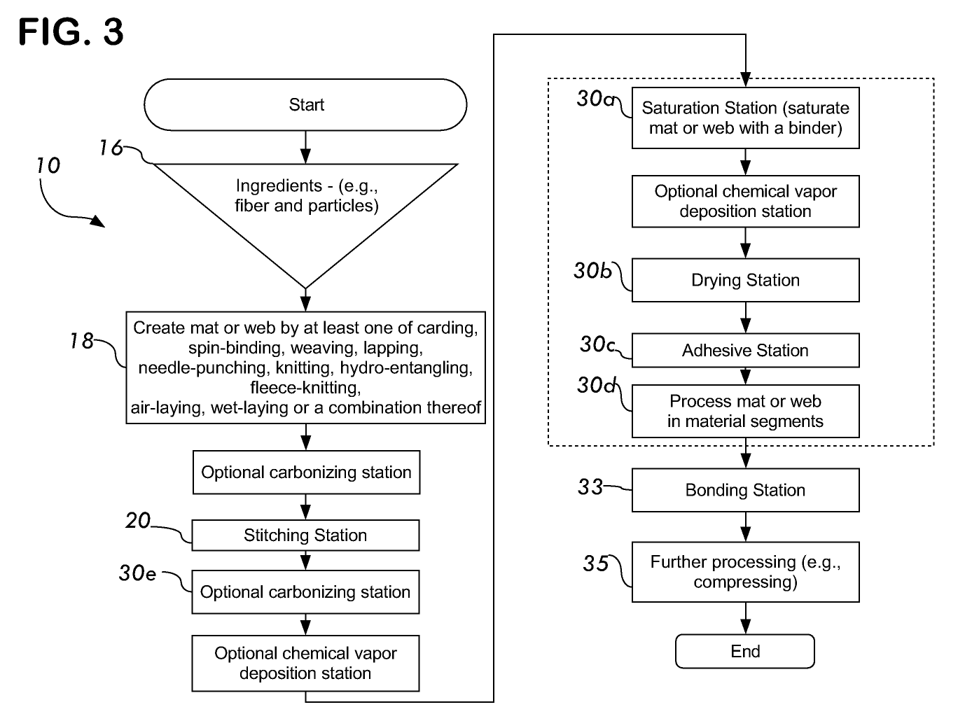

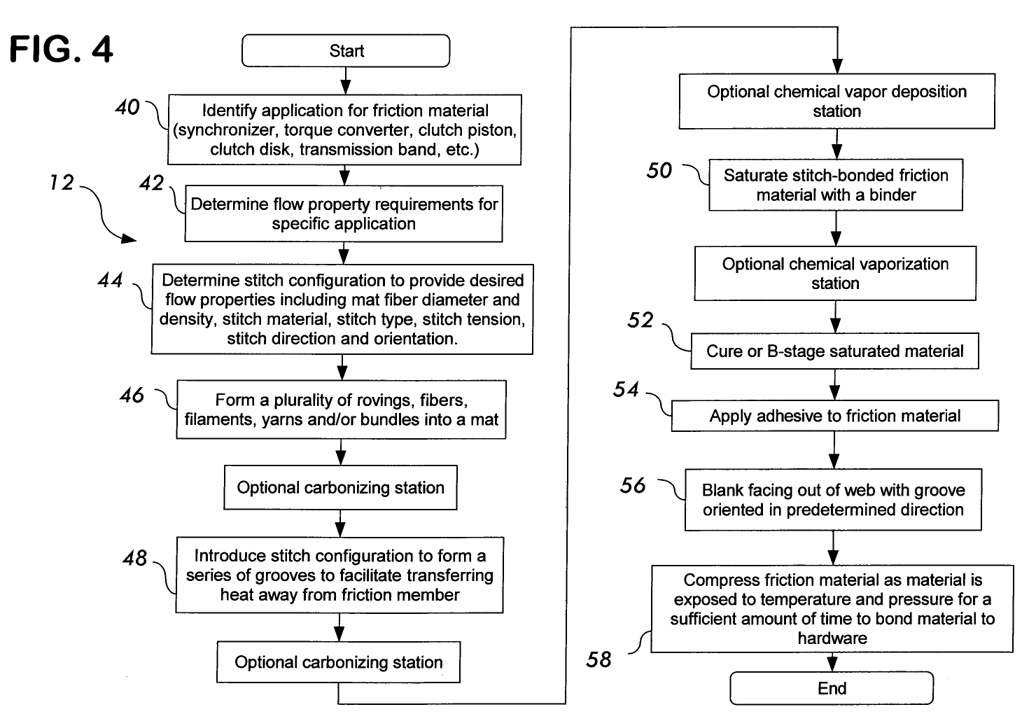

A system 10 (FIG. 3) and method 12 (FIG. 4) in accordance with one embodiment of the invention will now be described. In the embodiment, the system 10 is suitable for making a mat or web 14 of friction material for use in creating and making a friction material and friction material segments 26 (FIG. 15A) that may be used in a friction environment (not shown) in the manner described herein.

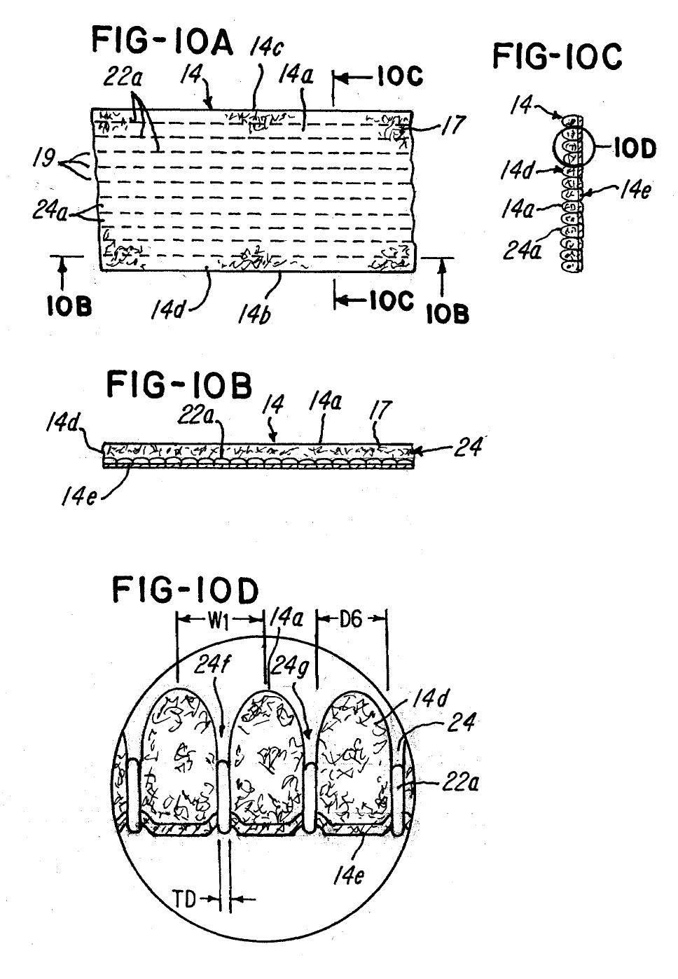

The method 12 (FIG. 4) includes the step of identifying the application for the friction material (block 40 in FIG. 4). For example, a determination is made as to what friction element (e.g., a synchronizer ring, torque converter, clutch piston, clutch disk, transmission band) the friction material segment 26 (FIG. 15) will be mounted on is shown at block 40 and FIG. 4. After the application is identified, the method or process continues by determining the flow property requirements or desired characteristics for the application in block 42 (FIG. 4). Next, a determination is made of the particular stitch pattern or configuration 19, as in the examples shown in FIGS. 10A and 14A, to provide the desired flow properties, including the mat or web 14 fiber diameters, density, stitch material, stitch type, stitch pattern, stitch tension, stitch direction and stitch orientation as may be necessary to achieve the desired or predetermined flow property requirements. This is performed at block 44 in FIG. 4.

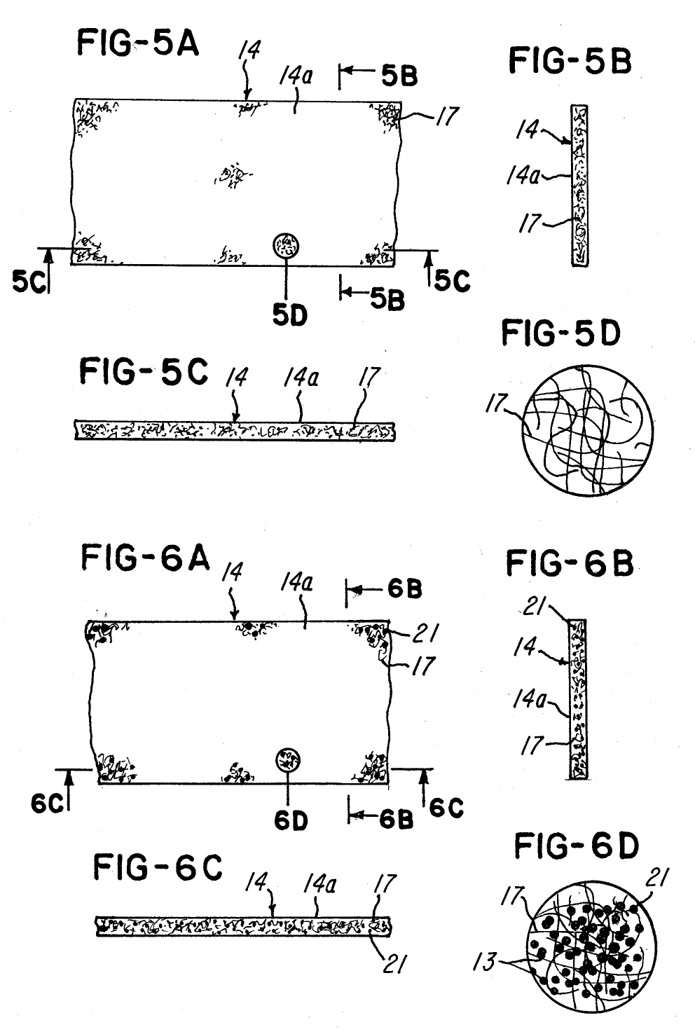

The system 10 begins at block 16 (FIG. 3) wherein a plurality of ingredients 13 (FIG. 6D), such as fibers 17 (FIG. 5D) and particles 21 (FIG. 6D) is provided. In the illustration being described, the plurality of ingredients 13 may comprise a plurality of rovings, fibers, filaments, yarns or bundles that range in length between 0.1 millimeter and 300 millimeters and vary in diameter between 1 micron and 500 microns. For example, note fiber or fibrous material 17 (FIG. 5A-5D) may comprise a natural or synthetic fiber, such as cotton, glass, wool, ceramic, carbon fiber, PAN, pre-oxidized PAN, KEVLAR®, polyamide, polyimide, polyamide-imide, acrylic, modacrylic, or olefin that are predominately arranged in a parallel orientation to one another. It should also be understood, however, that the mat or web 14 of fibrous materials may also be fibers, yarns, rovings and/or bundles that are arranged in any random orientation or cross-laid orientation for any desired orientation.

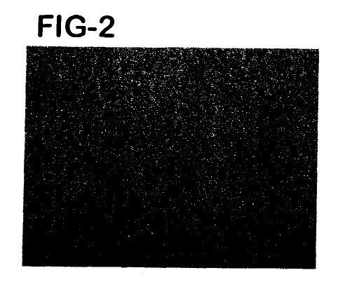

Correspondingly, at station 20 (FIG. 3), the system 10 includes station 18 (FIG. 3) for forming the plurality of rovings, fibers, filaments, yarns and/or bundles into the mat or web 14 (block 46 in the method shown in FIG. 4). FIGS. 2 and 5A-5D illustrate a mat or web 14 processed as described. At block 18 (FIG. 3), the mat or web 14 (illustrated in FIGS. 9A, 0A, 1A, 12A, 13A, 14A, 15A, 16A and 17A) is created or formed. The plurality of fibers, filaments, rovings, filaments, yarns and/or bundles can be consolidated and formed into mat or web 14 by one or more of a plurality of processes, including but not limited to, spin-binding, weaving, carding, lapping, fleece knitting, needle-punching, hydro-entangling, wet-laying or air-laying, or any combination thereof in order to form a continuous mat or web 14 that possesses enough strength to be carried through the appropriate processing device such as a carder, lapper or needle-punch (not shown). FIG. 2 illustrates a formed mat or web 14 prior to stitching.

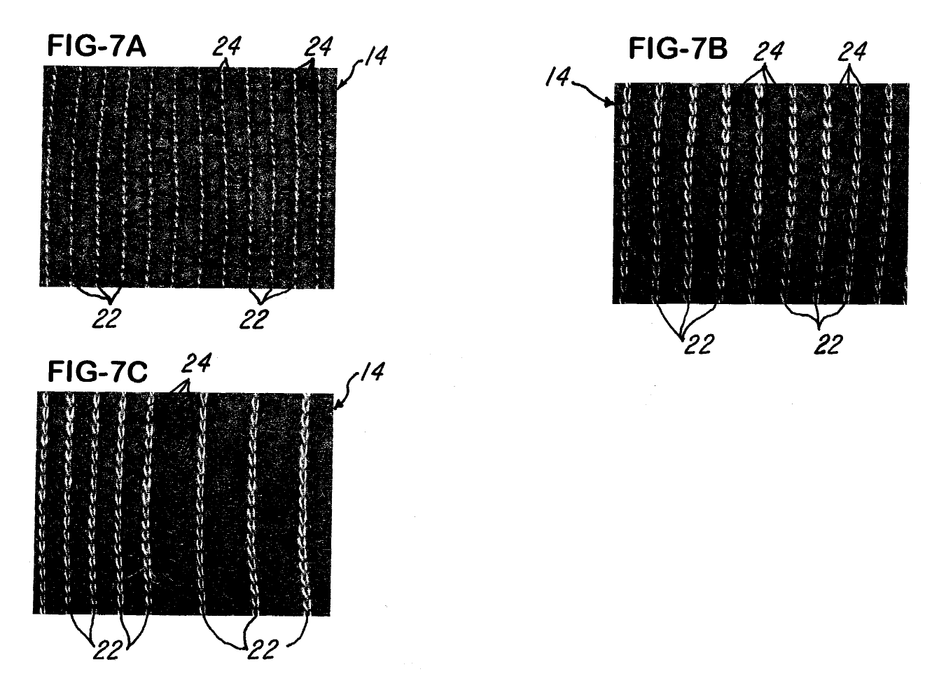

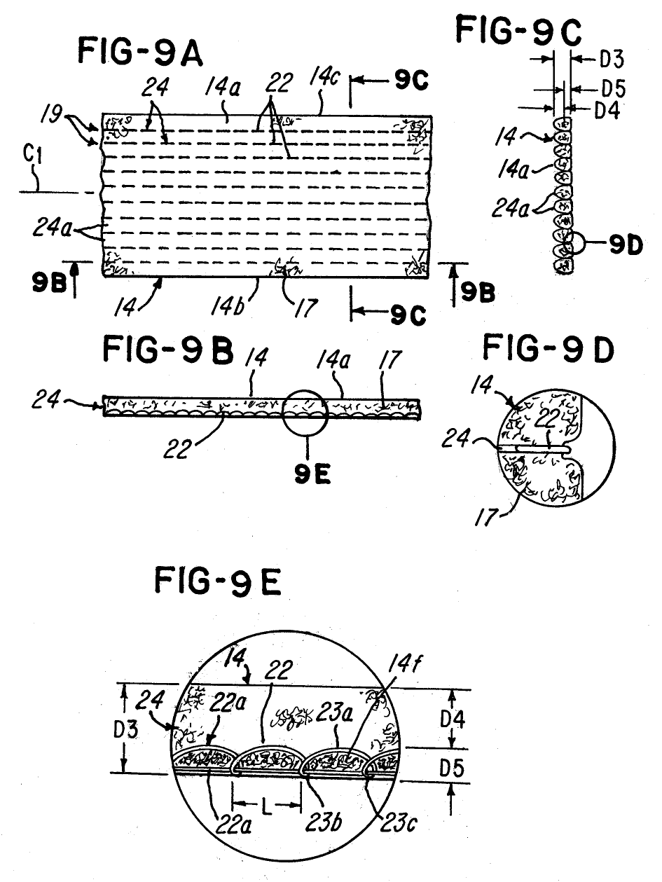

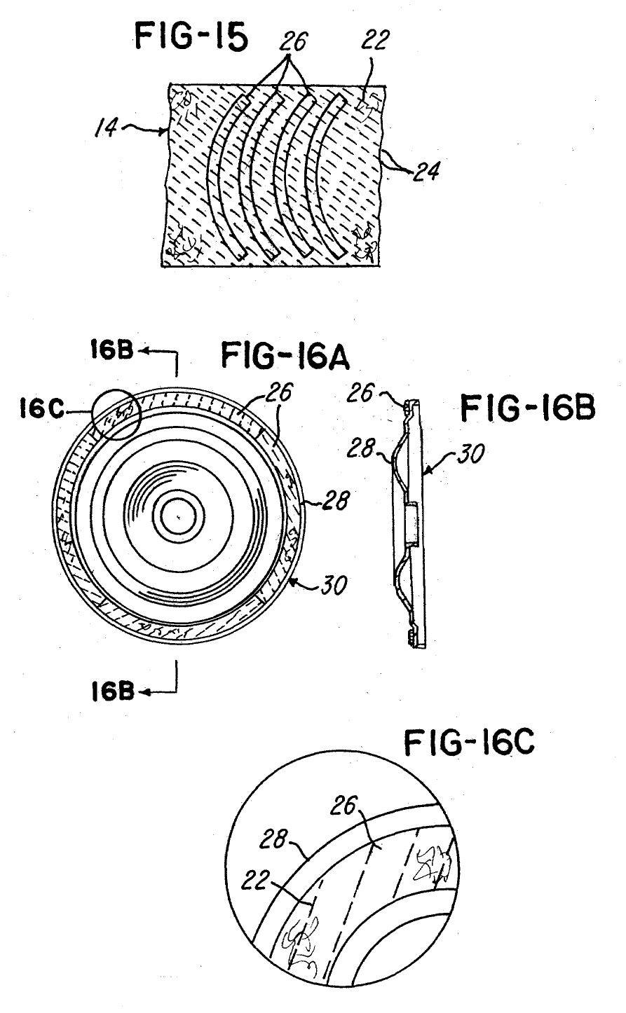

After the mat or web 14 has been formed, it is further processed at a stitching station 20 (FIG. 3). At the stitching station 20, a plurality of stitches 22 are sewn into the mat or web 14, as illustrated in FIGS. 7A-8C, 9A, 10A, 11A, 12A, 13A and 14A. At the stitching station 20 (FIG. 3), the predetermined pattern or configuration 19 (for example, FIG. 9A) determined at block 44 in FIG. 4 is stitched (block 48 in FIG. 4) into the mat or web 14 to form or introduce a plurality of grooves or channels 24 in the predetermined pattern or configuration in order to facilitate transferring heat away from the friction element or part 28 (FIG. 16) to which the plurality of segments 26 are blanked (block 56, FIG. 4). In this regard, the stitching station 20 (FIG. 3) may comprise a malivlies machine, malimo machine, maliwatt machine or other stitching equipment.

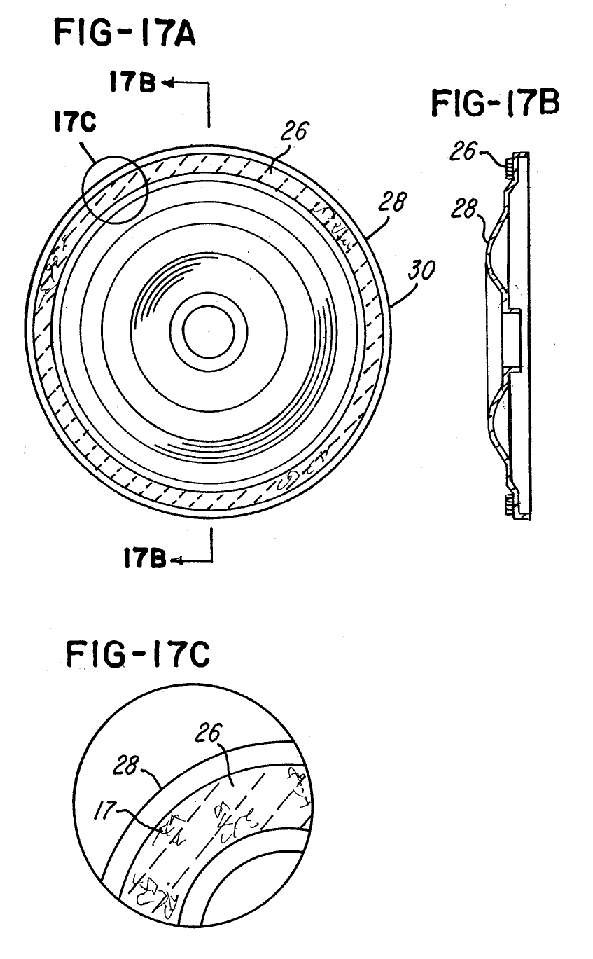

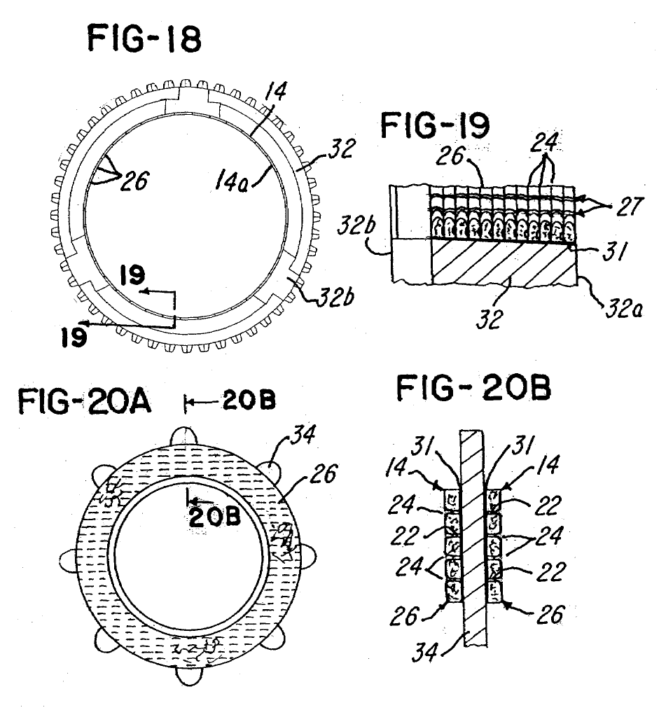

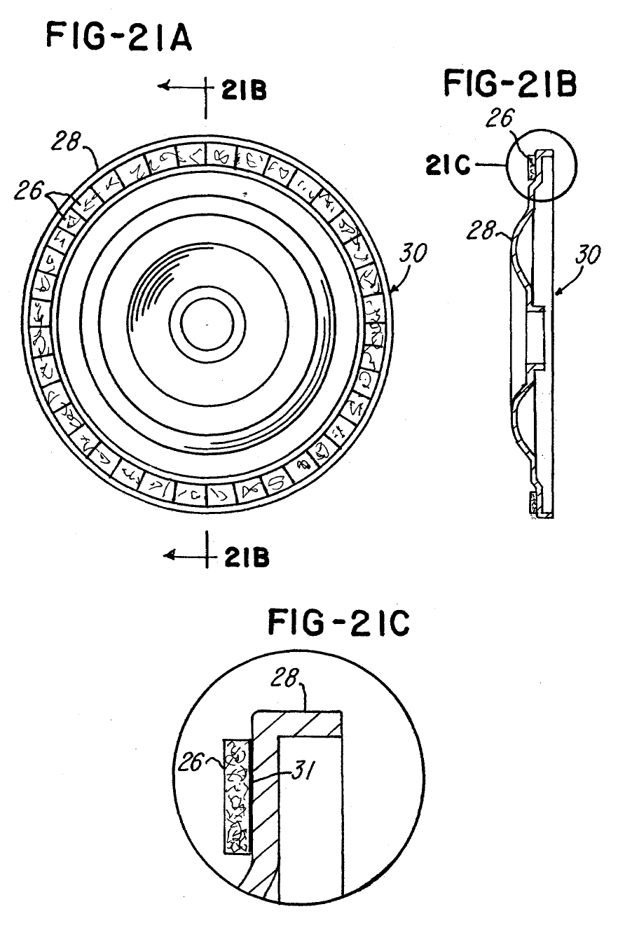

The plurality of stitches 22 form the plurality of rows or channels 24 that facilitate reinforcing the web or mat 14 and facilitate strengthening the web or mat 14. The plurality of stitches 22 also facilitate introducing or defining a texture or engaging area or surface, such as engaging surface 14a (for example, in FIGS. 9A-9C). The plurality of stitches 22 not only introduce the texture and engaging area or surface 14a to the surface 14, but also creates the plurality of channels, such as channels 24 illustrated in FIGS. 9C, 9D, 10C, 11B, 12D, 13B, 14B, 15B, 16B, 22, 23B, 24B and 19). In the illustration, the plurality of stitches 22 define a plurality of generally parallel rows, depressed or recessed areas in the illustration that, in turn, define or provide the plurality of channels 24, respectively. The web or mat 14 is processed in the manner described later herein into, for example, the plurality of material segments 26 (FIG. 15) mentioned earlier. As will be described later herein, the material segments 26 are placed onto a part, such as a clutch plate 30 (FIGS. 17A-17B, 21A-21B), synchronizer ring 32 (FIGS. 18-19) or disk or ring 34 (FIGS. 20A-20B).

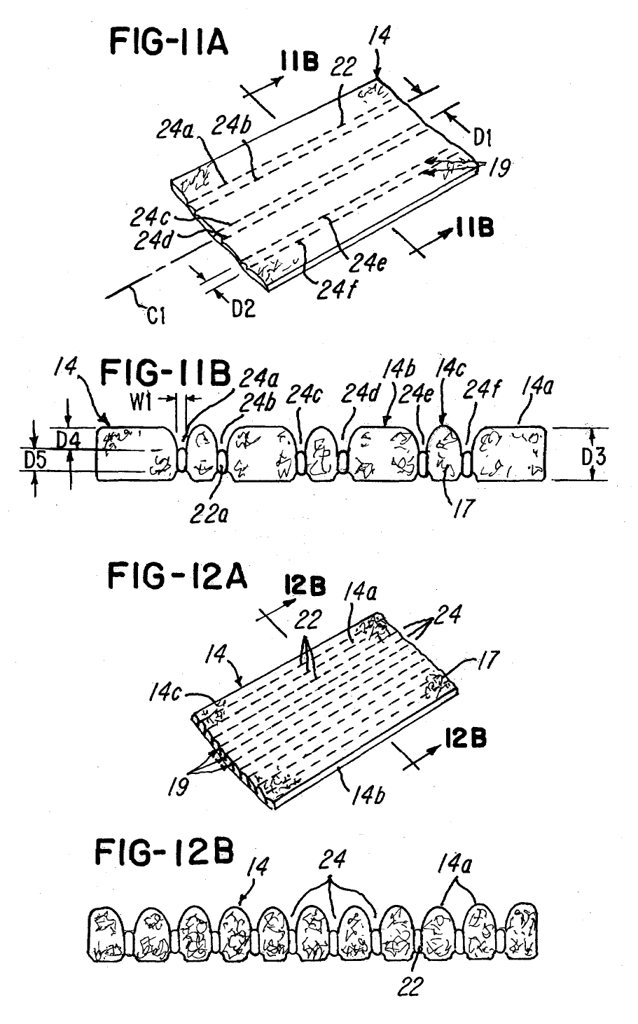

Notice that the plurality of stitches 22 defines the predetermined pattern or configuration 19 (FIGS. 9A and 11B) that is organized in the plurality of rows or channels 24 in the illustration being described. It should be understood that the predetermined pattern or configuration of the stitches 22 are selected to form the plurality of channels 24, respectively, to facilitate transferring heat away from the friction member or parts, such as parts 28 (FIG. 16A) and 34 (FIG. 20A), mentioned earlier herein. Thus, the predetermined plurality of channels 24 are patterned and configured to provide the desired flow properties and cooling requirements after it is determined what flow requirements are needed for a specific application.

FIGS. 7A-7C illustrates various microphotographs of a mat or web 14 with the stitches 22 of different types shown for illustration purposes. Note the distinct plurality of channels 24 created by the plurality of stitches 22, respectively. Of course, other stitch patterns and channels 24 will be created depending upon the stitch configuration selected, stitch pattern selected and the like.

Each of the plurality of channels 24 may be formed from a single stitch, such as stitch 22a (FIG. 9E), or multiple stitches 22, either of which comprise a continuous filament, fiber, thread, bundle or yarn that may comprise any natural or synthetic material fiber, such as cotton, glass, wool, ceramic, carbon fiber, PAN, pre-oxided PAN that can vary in diameter between, for example, 1 micron and 500 microns. The stitch 22a can be stitched from about two to sixty gauge, that is, two to sixty seams per inch in the illustration being described. Note also, that stitch length L (FIG. 9E) may vary being 0.05 millimeters to about 10 millimeters in the illustration being described.

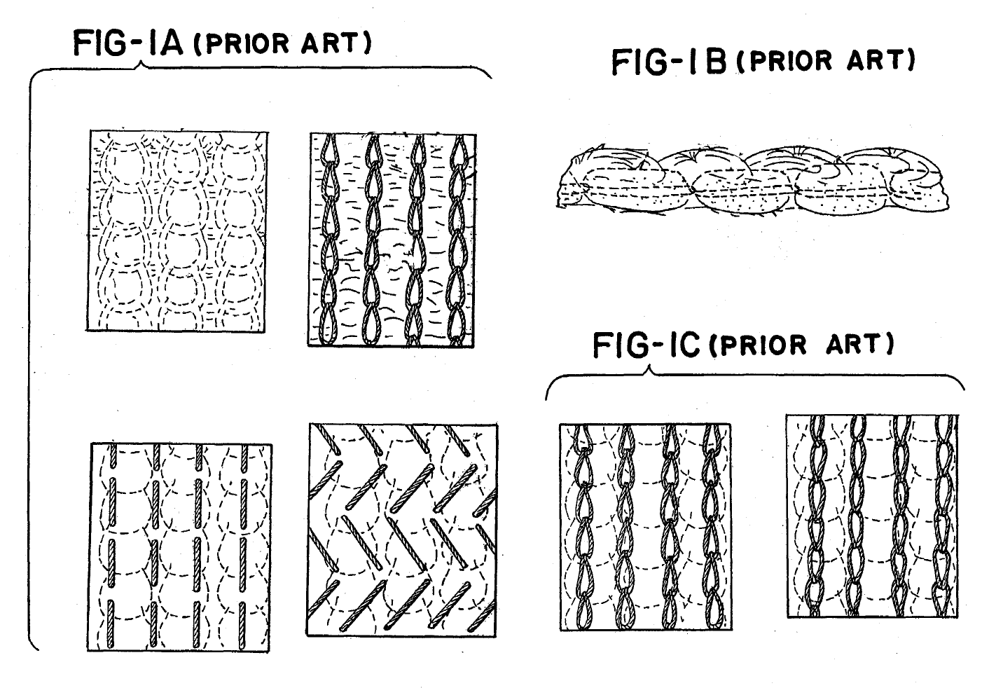

It should be understood that the mat or web 14 may contain a plurality of channels 24 that are equally or unequally spaced or oriented in either common or different directions. A single or multiple continuous channel (not shown) may also be stitched into the material mat or web 14. For example, notice the stitch patterns in FIGS. 9A, 1A, 11A, 12A and 13A, show the plurality of stitches 22 that define the plurality of rows or channels 24 that are generally parallel. In the illustration shown in FIGS. 9A-12A, the plurality of channels 24 extend in a direction generally parallel to a center line C1 (FIGS. 9A and 11A) between edges 14b or 14c of the mat or web 14.

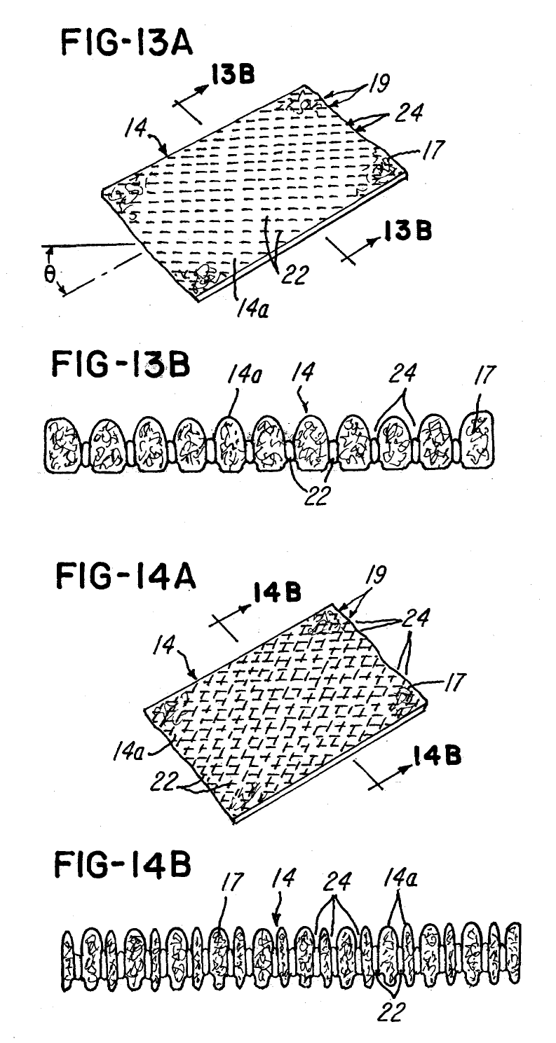

Note the illustration in FIG. 11A, wherein the plurality of channels 24 are arranged in a plurality of pairs or sets, namely channels or rows 24a-24b, 24c-24d, 24e-24f, with each of the pairs or sets being separated by a predetermined distance D1 (FIG. 11A), and each row or stitch 22 within each pair being separated by a distance D2. Thus, the plurality of channels 24 do not have to be equally spaced apart and can be oriented in any arrangement or configuration as desired. For example, the plurality of channels 24, shown in FIG. 11A, could be oriented in a manner such that they are not parallel to either the center line C1 or to one or more edges 14b and 14c of the web or mat 14. Note in the illustration shown in FIG. 13A that the plurality of rows or channels 24 are oriented on the mat or web 14 at a predetermined angle Θ, which, again, may be selected depending upon the fluid flow and cooling requirements or characteristics desired.

Thus, it should be understood that the mat or web 14 may be stitched with the plurality of stitches 22 that define the plurality of channels 24 that are equally or unequally spaced or oriented in a manner that is generally parallel or non-parallel to the center line C1 (FIG. 11A), which again will depend upon the application in which the mat 14 and friction materials segments 26 may be used. The plurality of stitches 22 do not have to be aligned parallel or linear, and each stitch pattern 19 and stitches 22 that make up that pattern could contain stitches or patterns that area non-linear, curved arcuate or assume any desired stitch shape.

It should be understood that a plurality of different types of stitches 22 or stitch patterns may be used to form the plurality of channels 24. These include, but are not limited to, a tricot, modified tricot stitch, run stitch, blatt stitch, bean stitch, underlay stitches, cross-stitches, moss stitch, chain stitch, open pillar, single thread chain stitch, single thread blind stitch, lock stitch, zigzag lock stitch, chain stitch, zigzag chain stitch, two needle bottom cover stitch, three needle bottom cover stitch, two needle chain stitch with cover thread, two thread over edge, three thread over edge stitch, mock safety stitch, two needle four thread over edge, four thread safety stitch, five thread safety stitch, two needle four thread cover stitch, three needle five thread cover stitch, four needle nine thread cover stitch, four needle six thread cover stitch, and combinations thereof.

It should be understood that the inventors have found various techniques or ways that have caused unexpected results in altering or changing the various characteristics of the plurality of channels or grooves 24, such as width W1 (FIG. 10D), depth, cross-sectioned shape or dimension, using various predetermined processing techniques that will now be described. As alluded to earlier herein, one technique is to change the orientation of the various stitch channels or seams 24. For example, the orientation may be the parallel orientation illustrated, for example, in FIGS. 12A-12B, a cross-hatched pattern (illustrated in FIGS. 14A-14B), or a plurality of circular, arcuate or curved seams or channels 24 (not shown). One or more of the plurality of channels 24 may be provided to have no orientation at all with respect to the other of the plurality of channels or seams 24.

Another predetermined technique for altering the texture or configuration of at least one or a plurality of channels 24 is to adjust a tension of one or more of the plurality of stitches 22, such as the stitch 22a shown in FIG. 9E. In this regard, the inventors have found that by reducing the tension of stitch 22a introduced in the mat or web 14, the density of the bundle of mat or web 14 contained by the stitch 22 will be decreased and result in a channel having a desired predetermined depth (e.g., depth D4 in FIG. 9E). Conversely, by increasing the tension of the stitch 22, the density of the bundle or mat or web 14 contained by the stitch 22 will be increased. The decrease or increase in tension results in a decrease or increase, respectively, in the depth D4 (FIG. 9E) of the associated channels 24. In this regard, notice in the illustration shown in FIG. 9E and FIG. 11B, that the mat or web 14 comprises a thickness D3, and the channel 24 illustrated has a depth D4, with a depth D5 of the stitch 22a making up the balance of the total thickness or depth D3. By tensioning the stitches 22, the depth D4 is increased, thereby making the area defined by the channels 24 larger. Using less tension causes the depth D4 of each of the channels 24 to be decreased. Thus, increasing, decreasing or varying the tension of one or more of the filaments 22a (FIG. 9E) making up the stitch 22 of the plurality of stitches 22 permits controlling the strength and fluid flow characteristics of the mat or web 14.

Another predetermined technique for adjusting the characteristics of one or more of the plurality of channels 24 is to increase or decrease the number of stitches per inch that defines each of the plurality of channels 24. For example, the inventors have found that increasing the number of stitches per inch of each stitch 22a that defines each of the plurality of channels 24 will result in more stitches and smaller volumes of the mat or web 14 contained within the constraints of each loop 23a in the stitch 22a. In this regard, notice in FIG. 9E, for example, that the stitch 22a comprises a portion 23a between loops 23b and 23c. The portion 23a captures the material 14e (FIG. 10B) of the mat or web 14 as shown. By increasing the number of stitches per inch, smaller volumes of the mat or web 14 contained within each stitch 22a (that is, the material 14e captured by a loop 23a of stitch 22a). Decreasing the number of stitches per inch results in larger volumes of the mat or web 14 contained within the constraints of each stitch, such as stitch 22a. In other words, as the stitches become larger, more of the web or mat 14 is captured by each stitch, while when the stitches become smaller less is captured by each stitch.

The number of stitches per inch has also been found to significantly affect the overall strength of the mat or web 14. By increasing the number of stitches per inch, for example, the overall strength of mat or web 14 is reinforced, while decreasing the number of stitches per inch decreases the overall strength and reinforcement of mat or web 14. In some cases, when the mat or web 14 has low strength prior to stitching, the addition of stitches into the mat or web results in an isotropic gain in mat or web strength. In other cases however, increases in strength by the addition of stitches may be anisotropic, requiring the addition of multi-directional stitch configurations to achieve high levels of strength throughout the material.

Still another effective way of changing a characteristic of one or more of the plurality of channels 24 can be accomplished by changing the characteristics of the rovings, fibers, filaments, bundles and/or yarns that are used to create mat or web 14. For example, increasing the diameter of the rovings, fibers, filaments, bundles or yarns has been found to reduce the depth and width of channels when the plurality of stitches 22 are introduced into the larger diameter fibers compared to the same fiber of a smaller diameter. The increased diameter of the rovings and fibers and the like that make up the mat material adds rigidity to the mat, reducing the deformation of the mat or web at locations where stitches are introduced. Less deformation of the mat or web 14 at the stitch location results in shallower channel depth and narrower channel width. Conversely, using smaller diameters within the mat or web 14 can result in less rigidity of the mat or web, causing increased bending and deformation of individual or groups of rovings, fibers, threads, filaments, bundles or yarns contained within the stitches, creating comparatively deeper and wider channels. Also, large diameter fibers, rovings and the like cannot be bundled or densified to the extent of smaller diameter elements due to larger voids that are present due to the geometrical interface of contacting large fiber diameters. When densifying material constrained by each stitch, more effective densification can be achieved with a mat or web 14 of small diameter components as intimate contact between adjacent fibers, rovings and the like is more readily achieved. More effective densification typical of small diameter fiber webs creates deeper and wider channels. Less effective densification typical of large diameter fiber webs creates shallower and narrower channels.

The stitch configuration selected can also be used to alter the compressive properties of the material. A stitch introduced with low tension with a low number of stitches per inch results in a low density stitched material. A low density mat will provide high compliance under load or possess a low compressive modulus. Increasing tension and number of stitches per inch results in an overall higher density material that is less compliant or possesses a higher compressive modulus.

Increasing tension can change surface texture of the mat or web 14 as mentioned earlier. A change in the geometry or diameter TD (FIG. 10D) of the filament or thread, such as thread 21 in FIG. 11B, causes a change in the texture of the mat or web 14. A larger diameter stitch 22a can reduce the depth D4 (FIG. 11B) of the channel 24 or texture imparted on the mat or web 14, while also creating a wider channel W1 at the surface 14a of the mat or web 14. Moreover, increasing the diameter TD of the fibers, thread, bundle, filaments, rovings or yarns used to stitch the mat or web 14 by increasing a diameter of the thread or filament 21 (FIG. 11B) used to make one of stitches 22, for example, the width W1 (FIG. 10D) of the channel 24 may be increased. A smaller diameter stitch 22a can increase the depth D4 (FIG. 11B) of the channel 24 or texture imparted on the mat or web 14, while also creating a narrower channel W1 at the surface 14A of the mat or web 14.

Still another effective way of changing a characteristic of one or more of the plurality of channels 24 can be accomplished by changing the characteristics of the assembly of rovings, fibers, filaments, bundles and/or yarns that are used to create the mat or web 14. Processes such a wet-laying on a fordinier, carding, lapping, needle-punching, or knitting or other processes can be used to form a woven or non-woven material to predetermined densities by altering the formation of such mats or webs by increasing or decreasing the packing of fibers, roving, etc. by utilizing methods known to those skilled in the art of such processes. A high density mat material provides high resistance to the tension applied by thread, bundle, yarn, etc. during stitching. The volume of mat contained within the stitch resists the tension applied by the stitch, resulting in a shallow channel. Conversely, the volume of mat contained within the stitch of low density mats does not provide resistance to the tension applied by the stitch, resulting in a relatively deep channel.

Notice in FIGS. 9A-9B, 10A-10B, 16A-16B, 11A-11B, 12A-12B, 13A-13B, 16A-16B, the plurality of rows or channels 24, such as channels 24, 24f and 24g in FIG. 10D; define engagement surfaces, such as surface 14a in FIG. 10D, comprising generally the same overall width or dimension D6. Note in contrast, that by varying the space between the rows, seams or channels 24 defined by the plurality of stitches 22, the friction engaging areas, such as areas 14b and 14c in FIG. 11A may be varied. This feature is illustrated in FIG. 11B. Notice the substantially larger area between channels 24d and 24e results in associated generally larger engaging surface area 14b, respectively, being substantially different. Thus, it should be understood that by varying the distance between adjacent rows of seams of the plurality of stitches 22, the friction engaging surface areas, such as the surfaces areas 14b and 14c illustrated in FIG. 11B, can be varied correspondingly.

Advantageously, increasing the diameter TD (FIG. 10D) of the stitch 22a fibers, thread, bundles and/or yarn used to stitch defining one of the plurality of channels 24, the web or mat 14 increases the maximum tension that can be applied to that element when compared to the element with a smaller diameter stitches 22. As mentioned earlier herein, increased tension can be used to change the surface texture of the mat or web 14. The geometry of a larger diameter stitches 22 can also reduce the depth D4 (FIG. 11B) of the associated channels 24 as well as the texture parted on the web or mat 14, such as surface area 14a (FIG. 9C). An increased diameter TD of stitch 22 can also create a wider channel 24 at the surface 14a of mat or web 14. The geometry of a smaller diameter stitch 22 can also increase the depth of the texture imparted at the web or mat 14, while also creating a narrower channel 24 at the surface 14 of the mat or web 14.

After at least one or plurality of mat or web 14 are stitched to provide the stitched mat or web 14, the mat or web 14 can comprise a basis weight between 20 pounds/3,000 square feet to 1,200 pounds/3,000 square feet without binder, however, preferably the desired basis weight is between 20 pounds/3,000 square feet to 600 pounds/3,000 square feet without binder but again other basis weights may be provided depending upon the application. The mat or web 14 thickness can range between 0.1 millimeter and 20 millimeters; however, it is preferably 0.4 millimeters and 1 millimeter. The groove or channel 24 or texture depth D4 (FIG. 9E) resulting from the introduction of the stitch can range between zero percent to 100% of the entire thickness of the mat or web 14 minus the diameter of the stitch element.

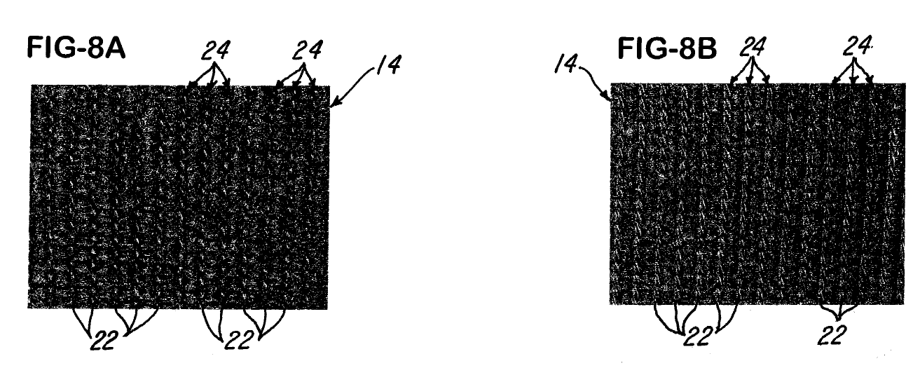

Referring back to FIGS. 3 and 4, the stitched mat or web 14 is transferred (block 50, FIG. 4) to a processing station e where the mat or web is optionally carbonized. Carbonizing may be performed before or after stitching. An additional chemical vapor deposition step may again be optionally performed after station 30a. After the optional carbonizing and/or chemical vapor deposition step, the mat may be transferred to a processing station 30a (block 30a, FIG. 3) where the mat or web 14 is saturated (block 50, FIG. 4) with a binder at a saturation station 30a (FIG. 3). FIG. 2 illustrates a microphotograph of the stitched mat or web 14 before the binder is applied. FIGS. 7A-7C show microphotographs of the finished processed stitched mat or web 14, and FIGS. 8A-8C show microphotographs of the same mat or web 14 after the binder is applied. FIGS. 7A-7C and FIGS. 8A-8C also show various stitch patterns that create well defined channels 24 or grooves through which fluid may flow and that provide reinforcing strength to the web or mat 14.

It should be understood that the binder can also reinforce the strength of the mat or web 14. When saturated with the binder at the saturation station 30a (FIG. 3), the web or mat 14 is caused to be submerged and past through a bath or pan (not shown) and impregnated with the binder. In the illustration being described, the binder may be a thermoset resin, a modified thermoset resin, thermoplastic resin, a powder resin or a blend of resins.

The mat or web 14 may contain the binder having a content ranging from one percent to about 90 percent of the saturated, dried and cured mat or web 14 material. Most preferably, however, it is desired that the binder content of the mat or web 14 be between about 20 percent and 50 percent of the weight of the saturated, dried and cured mat or web 14. In the illustration being described, the binder may be a thermoset resin, such as Ashland Aerofene 295-E-50, a modified thermoset resin such as Schenectady Chemical SP 6493C, thermoplastic resin such as Dow Corning P84, novalac phenolic resin such as Schenectady Chemical SP6300A, silicone resin such as Dow Corning 1107, cashew-based resin such as Cardolite 334, epoxy resin such as Shell Epon 1001B, polyamide such as Skybond 701, melamine resin such as Borden Cascomel MF-2LM, nitrile butadiene resin such as Noveon 1562117, acrylic binders such as HB Fuller PN 3178F.

Moreover, the binder may be in the form of fibers made of resin that are novaloid phenolic such as American Kynol 10BT, melamine fibers such as BASF Basofil, slot fiber, or powdered phenolics such as Plenco 12114 or a polyimide fiber such as Lenzing fiber.

Thus, in the illustration being described, the binder is comprised of one or more of the aforementioned resins mentioned earlier herein. Note, for example, FIGS. 5A and 5B, the web or mat 14 in FIG. 5A comprises the various fibers 17 that are processed at the station 18 to provide the mat or web 14. After the saturation station 30a, the mat or web 14 may be impregnated with the plurality of particular materials 21 or particles, as illustrated in FIG. 6D, such that the particles 21 disbursed among and throughout the fibers 17. As mentioned earlier, although not shown, the plurality of particulate materials or particles 21 may be applied solely to the surface, such as surface 14a (FIG. 6C).

The binder may contain particulate material 21 (FIG. 6D) comprising a minor dimension or diameter as small as 1 nanometer (nm) or a major dimension or diameter as large as about 500 micrometers. In one embodiment, the particles have a minor dimension of about 1 micrometer and major dimension of about 150 micrometers in the illustration being described. The particulate materials 21 may comprise carbonaceous materials, such as metallurgical coke, petroleum coke, carbonized PAN or pitch, graphite, activated carbon, industrial diamond or other materials. Such other materials may include, for example, metallic oxide materials, such as iron oxide, aluminum oxide, chromium ferrous oxide, silicacious materials such as boral silicate, quartz, diatomaceous earth: granulated elastomeric materials such as nitrile particles, nitrile butadiene particles, acrylic particles, cashew born polymer particles and alike. Moreover, the particulate material 21 made be symmetrical in shape, asymmetrical in shape and may comprise a carbide, such as silicone carbide; polymeric particles such as cashew particles, modacrylic, phenolic epoxy or minerals such as calcium carbonate, calcium metasilicate, flint and bit basalt.

In the illustration being described, the particulate material 21 (FIG. 6D) content ranges between about one percent to about eight hundred percent weight of the saturated, dried and cured mat/web material. Most preferably, the particulate material 21 comprises between about one hundred percent and two hundred percent weight of the saturated, dried and cured mat or web 14 material. The particulate material 21 may also comprise finely chopped fibers (not shown), which may be fibers so small that they are considered particles. Moreover, particles or particulate material 21 may be only applied to the surface, such as surface 14a (FIG. 6C), if desired.

After the mat or web 14 is saturated, either with or without particles 21 (FIG. 6D), at the saturation station 30a (FIG. 3) as described at block 50 (FIG. 4), the mat or web 14 is transferred (block 52, FIG. 4) to a drying station (block 30b in FIG. 3) where it is cured or B-staged.

Next, the web or mat 14 is transferred (block 54, FIG. 4) to an adhesive station 30c (FIG. 3) wherein an adhesive 31 (FIGS. 19, 20B and 21C) is applied to the mat or web 14.

Thereafter, the mat or web 14 is transferred (block 56, FIG. 4) to a further processing station 30d (FIG. 3) where the mat or web 14 may be blanked (as illustrated in FIG. 15) for groove orientation in a predetermined direction (block 56, FIG. 4) to provide the plurality of friction material segments 26. In this regard, notice that the predetermined configuration or pattern 19 (FIG. 11A) of the plurality of channels 24 is oriented at a predetermined angle relative to edge 14b when the material segments 26 are blanked at the station 30d (FIG. 5), so that the grooves or channels 24 are oriented in the predetermined direction relative to the center line C (FIG. 11A) or edges, such as edges 14b and 14c in FIG. 11A.

It should be understood that before being applied to an energy absorption transmission element or device, such as a plate 30 (FIGS. 16A and 17A), the saturated mat or web 14 must be substantially or fully cured or B-staged to a volatile content between 0.1 percent and about 25 percent or cured between 75 percent and 99.9 percent.

After the stitched web or mat 14 is cured, it is blanked (block 30d in FIG. 3, block 56 in FIG. 4) into the plurality of material segments 26 created in the manner described earlier herein relative to the station 30d (FIG. 3). As mentioned earlier, the plurality of material segments 26 are transferred to the bonding station 33 (FIG. 3) and the plurality of material segments 26 are bonded or adhered (block 58, FIG. 4) to the friction element or part 28 (FIGS. 16A-16C). The plurality of the material segments 26 are exposed to a temperature and pressure during bonding sufficient enough to bond the plurality of material segments 26 to the part 28. Notice that the web or mat 14 is blanked such that the channels 24 become situated in the desired position or location on the part 28 on which the segments 26 are adhered. The direction or orientation of the channels 24 will depend upon the configuration 19 selected and/or the orientation of the segments 26 on the part.

The plurality of friction material segments 26 may be further processed at station 35 in FIG. 3 by compressing the friction segments 26 between one percent and 95 percent during the bonding step, which also facilitates adhering the material to the friction element, such as the parts illustrated in FIGS. 16A-16C, 17A-17C, 18-19, 20A-20B and 21A-21C, as well as creating sufficient texture cooling grooves or channels 24 for the desired application. In this regard, a die (not shown) may be used to compress the plurality of friction material segments 26 during the compression step mentioned earlier. The die (not shown) may comprise embossing means (not shown) for embossing additional grooves, such as grooves 27 in FIG. 19, to provide grooves in addition to those defined by the plurality of stitch, rows of stitches or stitch patterns that define the plurality of channels 24 or which are sufficient to provide a surface texture on the material. For example, FIG. 19 illustrates an embodiment where the grooves or channels 24 are oriented such that they are generally parallel relative to an axis of the friction element on which the segments 26 are mounted, which is a synchronizer ring 32 in the illustration. Note, for example, that the channels 24 extend from the first side 32a (FIG. 19) to the second side 32b as shown. At least one or a plurality of cross grooves or channels 27 may be stitched or embossed by the die. As mentioned earlier, it should be understood that the predetermined configuration or pattern 19 of channel 24 will be selected depending upon the amount of cooling or fluid flow transfer that is desired across the part, such as parts 28 (FIG. 16A), 30 (FIG. 16A), 32 (FIG. 18) and 34 (FIG. 20A).

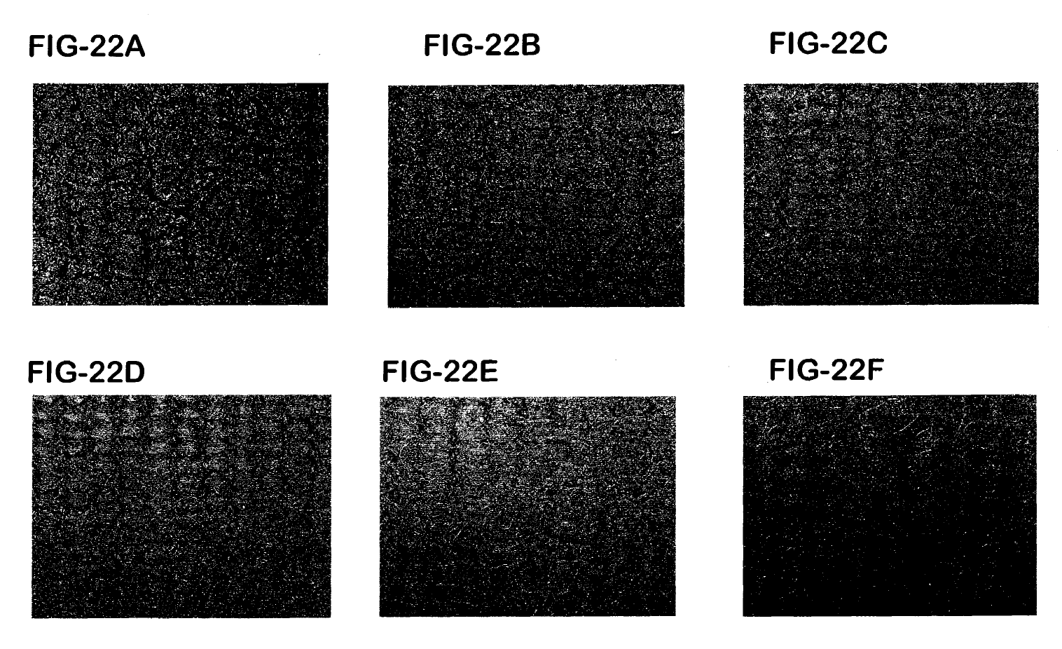

An optional compression step (block 58 in FIG. 4) may be performed to change the characteristics of plurality of channels 24. For example, FIGS. 22A-22F are microphotographs of different levels of compression and the comparison of the overall impact of the levels of compression have on the plurality of channels 24. FIG. 22A illustrates a microphotograph of the stitched mat or web 14 that has been compressed zero percent, FIG. 22B seven percent, FIG. 22C twenty-two percent, FIG. 22D thirty percent, FIG. 22E forty percent, and FIG. 22F fifty-five point six percent. In general, as the compression increased, the overall depth and size of the channel decreased. In contrast, when the compression decreases, the plurality of grooves or channels 24 remain relatively defined and retain their characteristics, especially when there was zero percent compression.

Referring back to FIGS. 3 and 4, note that a further processing station may be included to provide further processing, such as embossing, machining, lasering or a combination thereof at block 35 (FIG. 3).

Although not shown, it should be appreciated that the plurality of stitches 22 or rows of stitches 22 that form the plurality of channels 24, respectively, may comprise the same cross-sectional dimensions, such as width W1 (FIG. 10D), or they may be different. A channel 24 having a first width defined by a first yarn, for example, may be substantially smaller or larger than an adjacent or other channel 24 defined by a second stitch 22 comprising a different type of yarn, different diameter or different stitch pattern. It should be understood that the plurality of stitches 22 do not have to be the same and may utilize different types rovings, yarns, fibers, or bundles, for example, even along a single row of stitches 22, as may be necessary to provide the desired pattern or configuration 19 of channels 24. Thus, although the illustrations show stitch 22a that is generally constant along its cross-sectional length, a mixture of fiber stitches, thread tensions, and thread diameters and the like may be used in a single row in order to change the dimensions, such as width TD (FIG. 10D) or depth D4 (FIG. 9E) of one of more of the plurality of channels 24 along their length.

As alluded to earlier, the plurality of channels 24 do not have to be parallel, and they can assume any orientation relative to each other. Thus, for example, one channel 24 could be provided that is generally perpendicular to another channel, as illustrated by the channels 27 and 24 in FIG. 19 or one row of stitches 22 could be perpendicular, for example, to another row of stitches 22. This may be desirable if, for example, it is desired to provide fluid communication with one or more of the plurality of rows of channels 24 and one or more other channels by providing a row of stitches 22 across the plurality of channels 24.

Thus, it should be understood that while the embodiments illustrated show a plurality of grooves or channels 24 that are generally parallel and linear, other patterns or configurations 19 could be selected. For example, the cross channels or grooves 27 (FIG. 21B) may be provided by stitches (not shown) or embossing when the plurality of friction materials segments 26 are bonded onto the part 28. Also, non-linear stitches rows or patterns of stitches 22 may be used, such as circular, curved, arcuate as the line.

Advantageously, system 10 (FIG. 3) and method 12 (FIG. 4) provide a web or mat 14 with the plurality of stitches 22 that form the plurality of rows or grooves or channels 24, respectively, in the predetermined configuration or pattern 19 that is determined based upon the fluid flow characteristics and cooling desired.

It has been found that one or more of the embodiments being described are particularly useful in the power absorption or power transmission assembly of the type having a plurality of mating friction elements that change from a position of complete engagement to a position of disengagement. In such an environment, the assembly (not shown) includes the first member, such as the part 28 in FIG. 21A and a mating second opposing member (not shown).

The method illustrated in FIG. 4 discloses the method of making the friction facing material segments 26 for use in the power-absorption transmission assembly that involves the steps of consolidating the primary web or mat 14 in the manner described earlier and stitching the primarily web or mat 14 with, for example, the stitch 22a or warp yarn as illustrated earlier. A broad range of patterning and surface texturing is made possible by the above-mentioned process or method and system and variations in the patterns can be accomplished by adjusting the warp yarn needle spacing, warp yard stitch length, warp yarn diameter and tension as described earlier.

As mentioned earlier, the primary web or mat 14 may be knitted, fleece-knitted, carded, spun-bounded, woven, hydro-entangled, air-laid, wet-laid, lapped or a combination thereof multiple times or may even be combined with other webs or mats 14. The plurality of mats or webs 14 may be knitted, fleece-knitted, carded, spun-bond, woven, lapped, hydro-entangled, needle-punched, and then stitched together to provide a multi-layered mat or web that may be then be processes as in the manner described earlier relative to a previous illustrations described. In the illustration being described, the consolidated mat or web 14 is shown in FIG. 11A, for example, as a single layer of the mat or web 14. However, the mat or web 14 could be stitched in multiple layers such as the two layers 14d and 14e illustrated in FIG. 10D.

Advantageously, the system 10 (FIG. 3) and method 12 (FIG. 4) provide a stitched friction material method of making such material having predetermined channels 24 that may be used in a friction facing environment, such as a synchronizer ring 32 (FIG. 18), clutch disk 34 (FIG. 20A), torque converter 30 (FIG. 17A), piston or the like. However, it is contemplated by the inventors that the material may be applied to other environments such as wet brake applications, dry brake applications, dry clutches, transmission bands, launch clutches, pump swash plates, differential clutches, cone clutches, input shaft brakes, or bridging clutches.

While the materials, parts and method herein described and the form of apparatus and system for carrying the method into effect, constitute preferred embodiments of the invention, it should be understood that the invention is not limited to this precise method and form of apparatus and the changes may be made in either without departing from true spirit in the scope of the invention that is defined in the appended claims.

What is claimed is:

1. A friction material comprising:
a plurality of materials formed to provide a web from which a friction material segment is provided; and
a plurality of stitches in said web to provide a stitched web; said plurality of stitches defining a plurality of channels in said friction material segment to facilitate transferring heat away from a friction element onto which said friction material segment is situated.

2. The friction material as recited in claim 1 wherein said plurality of materials comprises a plurality of rovings, a plurality of fibers, a plurality of filaments, a plurality of bundles, or a plurality of yarns that are assembled as a woven or non-woven web

3. The friction material as recited in claim 1 wherein said plurality of stitches comprises a plurality of rovings, a plurality of fibers, a plurality of filaments, a plurality of threads, a plurality of bundles, a plurality of yarns, or plurality of braids.

4. The friction material as recited in claim 3 wherein said plurality of stitches, comprises synthetic rovings, fibers, filaments, threads, bundles, yarns or braids.

5. The friction material as recited in claim 3 wherein said plurality of stitches, comprises metallic and/or non-metallic fibers, filaments, threads, bundles, yarns or braids.

6. The friction material as recited in claim 1 wherein said plurality of stitches comprises of fiber, filament, thread, bundle, yarn or braid.

7. The friction material as recited in claim 1 wherein said plurality of channels are arranged over a surface of said friction element when said friction material segment is placed on said friction element.

8. The friction material as recited in claim 1 wherein said plurality of channels are generally parallel.

9. The friction material as recited in claim 1 wherein said friction element comprises a first edge and a second edge, said plurality of channels extending between said first and second edges.

10. The friction material as recited in claim 1 wherein said plurality of stitches define a plurality of channels located in an interior area of said friction material segment.

11. The friction material as recited in claim 1 wherein said stitched web is saturated with a binder.

12. The friction material as recited in claim 11 wherein said binder is a resin char matrix.

13. The friction material as recited in claim 1 wherein said web is saturated with a binder, said binder comprising a plurality of particles dispersed throughout.

14. The friction material as recited in claim 13 wherein said particles comprise a carbonaceous material, a nitiride material, a metallic oxide material, a silicacious material, a powdered elastomeric material, a carbide material, a polymeric material or a mineral.

15. The friction material as recited in claim 13 wherein said particles range in diameter between 1 nanometer and 500 micrometers.

16. The friction material as recited in claim 1 wherein said stitched web has particles applied to at least one surface thereof.

17. The friction material as recited in claim 1 wherein mat material is carbonized before stitches are introduced into the mat.

18. The friction material as recited in claim 1 wherein at least a portion of mat material is carbonized after stitches are introduced into the mat.

19. The friction material as recited in claim 1 wherein at least a portion of the mat material has a material deposited on at least one surface by a chemical vapor deposition process.

20. The friction material of claim 13 wherein said binder contains petroleum coke particles.

21. The friction material of claim 13 wherein said binder contains metallurgical coke particles.

22. The friction material of claim 13 wherein said binder contains activated carbon.

23. The friction material of claim 13 wherein said binder contains graphitic carbon.

24. The friction material as recited in claim 1 wherein said friction element comprises a torque transmission device.

25. The friction material as recited in claim 24 wherein said torque transmission device is a synchronizer.

26. The friction material as recited in claim 24 wherein said torque transmission device is a torque converter clutch piston.

27. The friction material as recited in claim 24 wherein said torque transmission device is a clutch plate.

28. The friction material as recited in claim 1 wherein said web comprises a plurality of layers.

29. The friction materials as recited in claim 1 wherein the plurality of stitches comprises a predetermined characteristic.

30. The friction material as recited in claim 29 wherein each of said plurality of stitches being formed with a filament, fiber, thread, bundle, braid or yarn having a predetermined diameter, wherein the predetermined diameter varies directly with a size of channel which it forms.

31. The friction material as recited in claim 29 wherein said predetermined characteristic is a predetermined tension applied to at least one of said plurality of stitches.

32. The friction material as recited in claim 1 wherein said plurality of stitches each define a row of stitches having between two and sixty stitches per inch.

33. The friction materials as recited in claim 1 wherein each of plurality of stitches includes at least one of a tricot, modified tricot stitch, run stitch, blatt stitch, bean stitch, underlay stitches, cross-stitches, moss stitch, chain stitch, open pillar, single thread chain stitch, single thread blind stitch, lock stitch, zigzag lock stitch, chain stitch, zigzag chain stitch, two needle bottom cover stitch, three needle bottom cover stitch, two needle chain stitch with cover thread, two thread over edge, three thread over edge, mock safety stitch, two needle four thread over edge, four thread safety stitch, five thread safety stitch, two needle four thread cover stitch, three needle five thread cover stitch, four needle nine thread cover stitch, four needle six thread cover stitch, or combinations thereof.

34. The friction material as recited in claim 1 wherein mat material comprises a predetermined characteristic.

35. The friction material as recited in claim 1 wherein said mat material comprises a plurality of fibers, a plurality of filaments, a plurality of bundles, or a plurality of yarns with a predetermined diameter.

36. The friction material as recited in claim 1 wherein said mat material comprises a plurality of fibers, a plurality of filament, a plurality of bundles, a plurality of yarns that are assembled as woven or non-woven material by a wet-laid, air-laid, carded, lapped, needle-punched, or knitted process to a predetermined density.

37. A friction material segment comprising:
a material segment; and a plurality of stitches stitched in a predetermined pattern in said material segment; said plurality of stitches defining a plurality of channels through which fluid may flow to facilitate cooling a friction element on which said material segment is adhered.

38. The friction material segment as recited in claim 37 wherein said plurality of channels are generally parallel channels.

39. The friction material segment as recited in claim 37 wherein said material segment comprises a first edge and a generally opposed second edge; said plurality of stitches defining a plurality of generally parallel channels that are generally linear and situated at a predetermined angle relative to said first edge.

40. The friction material segment as recited in claim 39 wherein said plurality of stitches are situated at a predetermined angle relative to a center line of said material segment.

41. The friction material segment as recited in claim 40 wherein said material segment is stamped from a sewn web comprising said plurality of stitches.

42. The friction material as recited in claim 37 wherein said material segment comprises a plurality of materials comprising a plurality of rovings, a plurality of fibers, a plurality of filaments, a plurality of bundles, a plurality of yarns or a plurality of yarns assembled as a woven or non-woven material that is wet-laid, air-laid, carded, lapped, needle-punched, or knitted.

43. The friction material as recited in claim 37 wherein said plurality of stitches comprise fiber, filament, thread, bundle yarn, or braid.

44. The friction material as recited in claim 43 wherein said plurality of stitches comprises synthetic fibers, filaments, threads, bundles, yarns or braids.

45. The friction material as recited in claim 43 wherein said plurality of stitches comprises natural fibers, filaments, threads, bundles, yarns or braids.

46. The friction material as recited in claim 37 wherein said stitched pattern defines a plurality of channels located in an interior area of said friction material segment.

47. The friction material as recited in claim 37 wherein said material segment is saturated with a binder.

48. The friction material as recited in claim 37 wherein said material segment comprises particles applied to at least one surface thereof.

49. The friction material as recited in claim 48 wherein said particles comprise a carbonaceous material, a nitiride material, a metallic oxide material, a silicacious material, a powdered elastomeric material, a carbide material, a polymeric material or a mineral.

50. The friction material as recited in claim 49 wherein said particles range in diameter between 1 nanometer and 500 micrometers

51. The friction material as recited in claim 47 wherein said binder comprises a plurality of particles dispersed throughout.

52. The friction material of claim 51 where said binder contains petroleum coke particles.

53. The friction material of claim 51 where said binder contains metallurgical coke particles.

54. The friction material of claim 51 where said binder contains activated carbon.

55. The friction material of claim 51 where said binder contains graphitic carbon.

56. The friction material as recited in claim 37 wherein said friction element comprises a torque transmission device.

57. The friction material as recited in claim 56 where said torque transmission device is a synchronizer.

58. The friction material as recited in claim 56 where said torque transmission device is a torque converter clutch piston.

59. The friction material as recited in claim 56 where said torque transmission device is a clutch plate.

60. The friction material as recited in claim 56 wherein said friction material comprises a plurality of material segments that are stitched together.

61. A method for producing a friction material, comprising the steps of:
providing a plurality of rovings, fibers, filaments, bundles or yarns;
carding, spin-binding, weaving, lapping, needle-punching, knitting, hydro-entangling, fleece-knitting, air-laying, wet-laying or a combination thereof said plurality of rovings, fibers, filaments, yarns and or bundles into a mat or web; and
reinforcing said mat or web with a plurality of stitches, said plurality of stitches defining a plurality of channels, respectively.

62. The method as recited in claim 61 wherein said reinforcing step further comprises the step of:
reinforcing said mat or web with said plurality of stitches comprising a fiber, filament, thread, bundle, yarn or braid.

63. The method as recited in claim 61 where said mat or web undergoes a chemical vapor deposition process to deposit material to at least one surface thereof.

64. The method as recited in claim 61 where said mat or web is impregnated with a binder to form a saturated web or mat.

65. The method as recited in claim 61 where said mat or web contains a resin char matrix as a binder.

66. The method as recited in claim 63 where said chemical vapor deposition process is performed on at least a portion of the mat or web after said mat or web is impregnated with a binder.

67. The method as recited in claim 63 where said chemical vapor deposition process is performed before said mat is impregnated with a binder.

68. The method as recited in claim 61 where said mat or web undergoes a carbonizing process to carbonize at least a portion of the mat or web.

69. The method as recited in claim 68 where said carbonizing process is performed prior to said reinforcing step.

70. The method as recited in claim 68 where said carbonizing process is performed after said reinforcing step.

71. The method as recited in claim 64 wherein said binder comprises a plurality of particle materials dispersed therein, said process further comprising the step of:
applying the mixture of binder and said plurality of particle materials to at least a portion of said mat or web.

72. The method as recited in claim 64 wherein said method further comprises the step of:
drying the saturated web or mat to provide a dried web or mat.

73. The method as recited in claim 72 wherein said method further comprises the step of:
processing said dried web or mat into a plurality of friction material segments.

74. The method as recited in claim 73 wherein said method further comprises the step of:
adhering the plurality of friction material segments onto a part.

75. The method as recited in claim 74 wherein said part is a synchronizer ring, clutch disk, torque converter, or other torque transmission device.

76. A method for producing a friction element, comprising the steps of:
providing a part that is used in a friction environment;
providing a mat or web comprising plurality of rovings, fibers, filaments, bundles or yarns;
stitching said mat or web with a predetermined pattern of stitches to form a plurality of channels, respectively;
processing said mat or web to provide a plurality of material segments;
and adhering said plurality of material segments to said part such that said plurality of channels are situated in order to facilitate fluid to flow from a first area associated with a first side of said friction element to a second area associated with a second side of said friction element.

77. The method as recited in claim 76 where at least a portion of said mat or web undergoes a chemical vapor deposition process

78. The method as recited in claim 77 where said chemical vapor deposition process is performed after said mat or web is reinforced with a binder.

79. The method as recited in claim 77 where said chemical vapor deposition process is performed before said mat is reinforced with a binder.

80. The method as recited in claim 76 where said mat or web undergoes a carbonizing process to carbonize at least a portion of the web.

81. The method as recited in claim 80 where said carbonizing process is performed prior to said reinforcing step.

82. The method as recited in claim 80 where said carbonizing process is performed after said reinforcing step.

83. The method as recited in claim 76 wherein said method further comprises the step of:
forming said web or mat by carding, spin-binding, weaving, lapping, needle-punching, knitting, hydro-entangling, fleece-knitting, air-laying, wet-laying or a combination thereof said plurality of rovings, fibers, filaments, yarns and/or bundles.

84. The method as recited in claim 83 wherein said method further comprises the step of forming said web of pre-selected fiber geometries.

85. The method as recited in claim 83 wherein said method further comprises the step of forming said web of pre-selected density.

86. The method as recited in claim 76 wherein said stitching step is performed using a fiber, filament, thread, yarn, bundle, or braid.

87. The method as recited in claim 76 wherein method further comprises the step of:
impregnating said mat or web with a binder to form a saturated web or mat.

88. The method as recited in claim 87 where said mat or web contains a resin char matrix as a binder.

89. The method as recited in claim 87 wherein said method further comprises the step of:
dispersing a plurality of particle materials in said binder to provide a mixture of binder and said plurality of particles;
applying said mixture of binder and said plurality of particle materials to said mat or web.

90. The method as recited in claim 76 wherein said method further comprises the step of:
drying said saturated web or mat to provide a dried web or mat.

91. The method as recited in claim 90 wherein said method further comprises the step of:
processing said dried web or mat into a plurality of friction material segments.

92. The method as recited in claim 91 wherein said method further comprises the step of:
adhering the plurality of friction material segments onto a part.

93. The method as recited in claim 92 wherein said method further comprises the step of:
compressing the plurality of friction material segments to a predetermined depth before, during or after the adhering process.

94. The method as recited in claim 92 wherein said part is a synchronizer ring, clutch disk, torque converter, or other torque transmission device.

95. The method as recited in claim 76 wherein the stitching step further comprises the step of:
stitching said mat or web with a predetermined pattern of stitches that are tensioned at a predetermined tension.

96. The method as recited in claim 95 wherein the method further comprises the step of selecting said predetermined tension based upon a determination of the size of at least one of the plurality of channels.

97. The method as recited in claim 76 wherein said stitching step further comprises the step of selecting a plurality of fibers, rovings, filaments, threads, bundles or yarns that have a predetermined diameter selected based upon the size of at least one of the plurality of channels.

98. The method as recited in claim 76 wherein the stitching step is performed by using at least one of the following stitches patterns: tricot, modified tricot stitch, run stitch, blatt stitch, bean stitch, underlay stitches, cross-stitches, moss stitch, chain stitch, open pillar, single thread chain stitch, single thread blind stitch, lock stitch, zigzag lock stitch, chain stitch, zigzag chain stitch, two needle bottom cover stitch, three needle bottom cover stitch, two needle chain stitch with cover thread, two thread over edge, three thread over edge, mock safety stitch, two needle four thread over edge, four thread safety stitch, five thread safety stitch, two needle four thread cover stitch, three needle five thread cover stitch, four needle nine thread cover stitch, four needle six thread cover stitch, and or combinations thereof.

99. The method as recited in claim 89 wherein the plurality of particle materials include at least one of the following: carbonaceous materials, such as metallurgical coke, petroleum coke, carbonized PAN, or pitch, graphite, activated carbon, industrial diamond, metallic oxide materials, silicacious materials, or granulated elastomeric materials.

100. A system for making a friction element, said system comprising:
a mat station for creating a mat comprising a plurality of rovings, fibers, filaments, bundles or yarns;
a stitching station for stitching said mat with a predetermined pattern of stitches to form a plurality of channels, respectively;
a processing station for processing said mat or web to provide a plurality of material segments; and
a bonding station for bonding said plurality of material segments onto a part to provide said friction element such that said plurality of channels are situated in a predetermined order to facilitate fluid to flow from a first area associated with a first side of said friction element to a second area associated with a second side of said friction element.

101. The system for making a friction element as recited in claim 100 wherein said mat is processed through a carbonizing station prior to processing through said stitching station.

102. The system as recited in claim 100 wherein said system further comprises at least one of an optional carbonizing station for carbonizing at least a portion of said mat;
an optional chemical vapor deposition station for depositing material onto at least a portion of said mat;

103. The system as recited in claim 100 wherein said mat station further comprises:
means for performing at least one of carding, spin-binding, weaving, lapping, needle-punching, knitting, hydro-entangling, fleece-knitting, air-laying, wet-laying or a combination thereof of said plurality of rovings, fibers, filaments, bundles or yarns into a mat or web.

104. The system as recited in claim 103 wherein said means comprises a fordinier machine, a needle punch machine, a knitting machine, a hydro-entangling machine, a fleece-knitting machine, a rotoformer, an air-laying machine, or weaving machine.

105. The system as recited in claim 100 wherein said system further comprises a stitcher for stitching said predetermined pattern of stitches comprising a fiber, filament, thread, bundle, yarn or braid into said predetermined pattern.

106. The system as recited in claim 100 wherein said stitcher is a single needle machine, a multineedle machine, a malimo machine, a maliwatt machine, a malivlies machine.

107. The system as recited in claim 100 wherein said system further comprises a carbonizing oven for carbonizing said mat or web before or after stitching to form a stitched or non-stitched web carbonized to a predetermined level.

108. The system as recited in claim 100 wherein said system further comprises a chemical vapor deposition atmosphere for depositing material onto said mat or web before or after stitching.

109. The system as recited in claim 100 wherein said system further comprises an impregnator for impregnating said mat or web with a binder to form a saturated web or mat.

110. The system as recited in claim 100 wherein said system further comprises:
means for dispersing a plurality of particle materials in said binder to provide a mixture of binder and said plurality of particles and applying said mixture of binder and said plurality of particle materials to said mat or web.

111. The system as recited in claim 100 wherein said system further comprises:
means for dispersing a plurality of particle material to at least one surface of the mat or web.

112. The system as recited in claim 100 wherein said system further comprises the step of:
adhering the plurality of friction material segments onto a part.

113. The system as recited in claim 100 wherein said system further comprises the step of:
compressing the plurality of friction material segments before, during or after said adhering step.

114. The system as recited in claim 113 wherein said part is a synchronizer ring, clutch disk, torque converter, or other torque transmission device.

115. The system as recited in claim 114 wherein said torque converter comprises an outer diameter of greater than or equal to 282.5 mm and an inner diameter of less than or equal to 254 mm and said system is bonded to a carrier having a thickness of at least 0.6 mm when tested under a pressure of a least 400 kPa in a fluid with kinematic viscosity of about 9.32 cSt, without the addition of non-stitched channels, the flow rate across the wet-laid friction material ranges between about 0.2 l/min and 5.0 l/min

116. The system as recited in claim 114 wherein said torque converter part provides a slope greater than −0.35 NM/RPM between 20 and 60 RPM at 200 kPa, 400 kPa, 700 kPa when tested on a torque converter piston comprising a friction material assembly comprising an outer diameter of less than or equal to 282.5 mm and an inner diameter of greater than or equal to 254 mm with an effective piston surface greater than or equal to 102.32 square inches.
